(19) United States
(12) Patent Application Publication
(10) Pub. No.: US 2009/0135814 A1
(43) Pub. Date: May 28, 2009

(54) Method and device for tapping the payload data of multimedia connections in a packet network

(76) Inventors: Norbert Kreusch, Neuried (DE); Karl Lanzinger, Munchen (DE); Norbert Lobig, Darmstadt (DE)

Correspondence Address: K&L Gates LLP, P.O. BOX 1135, CHICAGO, IL, 60690, US

(21) Appl. No.: 11/660,637

(22) PCT Filed: Aug. 8, 2005
(86) PCT No.: PCT/EP2005/053888

§ 371 Date: Jul. 7, 2008

(30) Foreign Application Priority Data
Aug. 20, 2004 (DE) 10 2004 040 479.8

(51) Int. Cl. H04L 12/28; H04N 7/12

(52) U.S. Cl. 370/389; 375/240.01; 375/E07.001

(57) ABSTRACT

In one aspect, a method for tapping conventional multimedia connections such as video telephony according to Lawful Interception standards in a packet-oriented network is provided. A control, for the duration of a call, replaces the point-specific data of the respective partner end by the point-specific data of the tapping device, thereby guiding the useful data flows via the tapping device, tapping them and optionally adapting them to the interface of the tapping agencies.

### CROSS REFERENCE TO RELATED APPLICATIONS

This application is the US National Stage of International Application No. PCT/EP2005/053888, filed Aug. 8, 2005 and claims the benefit thereof. The International Application claims the benefits of German application No. 102004040479.8 DE filed Aug. 20, 2004, both of the applications are incorporated by reference herein in their entirety.

### FIELD OF INVENTION

The present invention relates to a method and device for tapping the payload data of multimedia connections in a packet network.

### BACKGROUND OF INVENTION

Modem communication architectures that utilize packet-based or cell-based methods such as Voice over IP (VoIP) or Voice over ATM (VoATM), for example, provide for separation of the connection control and the bearer channel control. The communication between one/a plurality of subscribers such as ISDN/PSTN subscribers, for example, routed via traditional circuit-switched telecommunication networks up to now, is then routed via IP networks. To continue to allow communication with traditional circuit-switched telecommunication networks such as PSTNs (Public Switched Telephone Networks), a “translation” between the two different transport technologies is required, which is performed in crosspoints. At such a crosspoint, the first transport technology for the payload information is converted into the second transport technology by using specific facilities designated as a Media Gateway (MG).

The Media Gateways themselves are controlled by central entities, the Media Gateway Controllers (MGC). The signaling information transmitted between two Media Gateway Controllers is transported, for example, by using a BICC protocol (Bearer Independent Call Control Protocol) or SIP/SIP-T protocol. The Media Gateway Controllers are essentially used for the coordination of the Media Gateways and monitor/control connections (bearer connections) between the Media Gateways. The control of the Media Gateways is effected, for example, with the aid of the MGCP (Media Gateway Controller Protocol) or the H.248 protocol.

In the case of packet-based connections, particularly in the case of connections routed via the IP network, the payload data stream is therefore routed direct between the subscribers or gateways involved outside the switching office. The legally prescribed possibility of tapping the payload data (Lawful Interception, LI), designated as LI for short in the following, is usually effected via a conventional interface outside the packet network, implemented in TDM technology. An outgoing call via the packet network with a pure audio connection from an A subscriber who has to be monitored is then tapped in a TDM loop. This means that a conversion to TDM must be performed first. There, the payload data is tapped, forwarded to the parties tasked in this respect (LEAs, Law Enforcement Agencies), designated as LEAs for short in the following, then converted back into the IP protocol and fed to the called subscriber (B subscriber).

The corresponding relationships are shown in FIG. 1. For the purposes of tapping the voice connections in the packet network, the data stream is routed via Media Gateways MG in a loop to the TDM network and back. In the TDM network, the data stream is tapped in the known manner.

However, the double conversion of the payload data stream brings with it serious disadvantages in terms of the end-to-end quality of the payload data transmitted. This would also apply particularly to video information which would have to be tapped in the case of video telephony. Moreover, this broadband payload data (>64 kbit/s, e.g. video) does not lend itself to problem-free transfer into the narrow-band TDM network. This is another reason why TDM Gateways are not equipped with video interfaces.

In the case of video telephony, mixed audio/video payload data is produced. As soon as a mixed audio and video connection is set up in the packet network, however, the video portion/stream would have to be suppressed in the case of tapping via TDM conversion. This has a strong adverse effect on the subscriber connection (no video image), however, and the monitoring function would be detectible to the monitored subscriber. There is, therefore, de facto no longer any possibility of tapping for a potential video connection, either for audio or for video. Only statistical data and signaling data (Interception Related Information, IRI) for the call can be secured.

In practice, this means that subscribers can only be monitored while they are making telephone calls in the TDM network. Since video telephony now occupies a permanent place in the service offerings of the fixed network operators, a problem arises here for the feature LI, since the associated video payload data stream is taken away from access by the LEAs (Law Enforcement Agencies) in the packet network. In the absence of corresponding standards, the LEAs currently have no IP-based interfaces. The intended rapid and broad-based introduction of video telephony accentuates the demand position for LI in this regard.

### SUMMARY OF INVENTION

An object underlying the invention is to disclose a way in which the feature LI can be deployed efficiently for multimedia connections.

An advantageous aspect of the invention is that the subscriber who has to be monitored does not notice the tapping of payload data, e.g. due to delays in the transmission of the payload data (lack of lip synchronization). Furthermore, the interventions in the packet-based switching system are minimal.

Thus, the logic or the switching technology of the packet-based switching system is not affected. Because of the processing of the payload data signal, existing interfaces of the LEAs can be used. The adaptations are effected in an LEA-specific manner, while the tapping and adaptation to LEA format can be effected in two stages in different facilities. This scheme also covers the serving of LEAs with new interfaces for classical TDM connections.

CallP features can also be covered with this scheme. Thus, monitoring in the case of activation of the features Call Forwarding or Call Transfer is just as possible as the monitoring of conferences

Mixed audio+video streams (e.g. coded in MPEGx) can be split, adapted to the needs of the LEAs. The audio and video signals can be transmitted in the form of two independent calls to the LEAs with conventional interfaces.

Finally, a step-by-step introduction of LEA access to the payload data of a multimedia connection is possible by adaptation of the type of payload data signal (none/audio only/video+audio, video+audio+data). The adaptation of the bandwidth of the video portion or of the overall audio+video stream is similarly possible (full bandwidth without changes, buffer storage and succeeding transmission with low bandwidth, processing and particularly compression to 64 kbit/s).

Advantageous developments of the invention are specified in the dependent claims.

### BRIEF DESCRIPTION OF THE DRAWINGS

In the following, the invention is explained in detail on the basis of an exemplary embodiment represented in the form of diagrams. The diagrams show:

FIG. 1 A network configuration with PSTN/ISDN terminals, Media Gateways and Media Gateway Controllers, and LEAs according to the prior art,

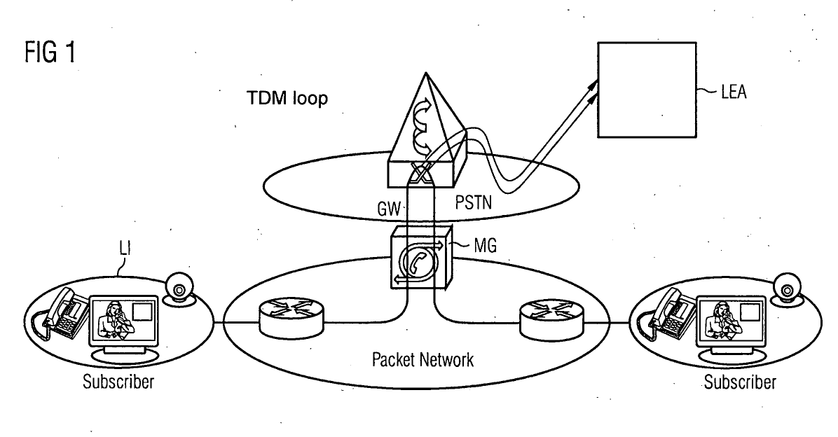

FIG. 2 An exemplary network configuration according to the invention,

FIG. 3 An exemplary logic of the conversion of the IP endpoint data in the case of LI in the packet-based switching system with the controller LICA,

### DETAILED DESCRIPTION OF INVENTION

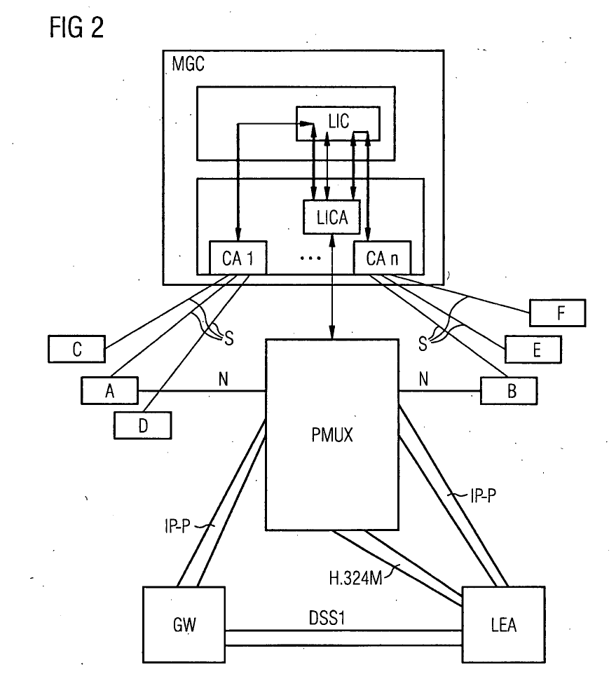

FIG. 2 shows the network configuration according to the invention. According to this, a plurality of terminals A . . . F is shown, which are led to a Media Gateway Controller or softswitch MGC via signaling connections S (subscriber signaling, intermediate exchange signaling). In this respect, the signaling connections are terminated in specific interface facilities, so-called Call Agent facilities CA (CA1 . . . CAn). The Call Agents CA are essential constituents of packet-based switching systems. Their task consists in controlling the remote terminals of the call in the packet network via standardized protocols, each Call Agent CA controlling a Half Call in each case. For the purposes of through-connection, the Call Agents exchange IP endpoint data IP-EPD of the terminals among themselves(e.g. via SDP). IP endpoint data IP-EPD contains, among other items, the IP addresses and port numbers of the terminals, and also information about the type of connection (audio, video, etc.), and the codecs used. The Call Agents CA involved in a call can be located in one or even in a plurality of switching systems. The exchange of the IP endpoint data IP-EPD is not affected by this, however.

According to the invention, a controller LICA (LI Connection Agent) and a packet multiplexer PMUX realized as a tapping device for tapping the multimedia stream are then provided. The (additional) packet multiplexer PMUX is looped into the packet data stream (payload data stream). The activation of said packet multiplexer PMUX leaves the switching software of the softswitch MGC unaffected by this. The controller LICA is realized as a pure software function unit, which is incorporated in the exchange of the IP endpoint data IP-EPD. It is located in one of the switching offices involved; but an arrangement outside the switching offices involved would be just as possible.

On the one hand, the controller LICA is in effective connection with a device LIC, which represents the LI Control. On the other hand, the packet multiplexer PMUX is activated by the controller LICA via a standard IP protocol such as H.248, for example. Furthermore, the knowledge that the feature LI is activated for at least one of the terminals is established in the controller LICA or alternatively the device LIC. The controller LICA receives this information following directory number analysis by the front-end function unit LIC or by its own activity (directory number trigger). In the latter case, the functionality of the LI Control LIC is reduced to the unconditional looping-in of a suitable LI Connection Agent LICA while taking account of the availability of LICA and packet multiplexer resources.

The controller LICA controls the data tapping transparently for the Call Agents CA. The IP endpoint data IP-EPD of the respective partner end is replaced by the IP endpoint data IP-EPD of the packet multiplexer PMUX. The payload data is therefore always routed via the packet multiplexer in the case of LI and tapped there, controlled by the controller LICA. The replacement does not affect the functionality of the Call Agents CA.

The controller LICA controls the connection of the packet multiplexer to the LEAs, which is preferably routed via an IP protocol IP-P (e.g. H.323 or SIP). If the tapping is to be effected in the TDM world (TDM LEA), the information that has to be tapped is fed via an IP protocol IP-P to a Gateway GW and from there, e.g. via a DSS1 protocol, to the LEAs.

The intervention of the controller LICA also supports switching functions (subscriber features) such as Call Forwarding or Call Transfer. All these features are handled in the usual way by the Call Agents CA. The algorithm of the IP endpoint data exchange always stays the same. This also applies to conferences, which can be monitored with the same method. In this respect, the conference point is situated in the terminal or a further facility, e.g. a central Media Server. In the case of conference functionality in the packet multiplexer, the conference point can also be situated there.

The payload data tapped in the packet multiplexer PMUX contains the audio stream and, depending on the capabilities of the LEAs, the video stream also. If only the audio portion should be required from a single data steam containing audio and video data (e.g. MPEG2 with audio+video) or if the video portion is needed separately for other technical reasons, the packet multiplexer splits the stream in the direction of the LEA (MPEG splitter). The payload data stream between the subscribers remains unaffected by this. According to the stipulations of the LEAs, the tapping is effected in such a way that the payload data stream coming from the A-end and the payload data stream coming from the B-end are forwarded separately in the direction of the LEA.

The packet multiplexer PMUX can deliver the tapped payload data in various ways depending on the requirement of the LEA:

1. Just the audio data is transmitted on two LI connections and sent to the LEA via an IP/TDM Gateway. The video data is not forwarded to the LEAs.

2. The audio data is sent to the LEA direct via a Gateway as in 1., the video data is placed in buffer storage and transmitted as TDM data to the LEA over and above the call (if the bandwidth makes this necessary) or even after the call.

3. The audio and video data is transferred to highly compressing codecs and transmitted to the LEAs direct and simultaneously as a TDM data stream or in the form of separate TDM data streams. (An example of this comprises the use of H.324M in the direction of the LEA.)

4. The audio and video data is transmitted unchanged via an IP protocol to an IP-LEA, that is to say an LEA with IP-based interfaces (SIP, H.323).

5. The adaptations to the interfaces of a plurality of LEAs can preferably be effected in a further subordinate facility for the purposes of payload data distribution. (2-stage method with tapping in a first facility and individual LEA adaptation and distribution in a second facility.) The latter possesses TDM interfaces for LEAs with conventional interfaces, or there is a further subordinate signaling and/or payload data converter (Gateway) on the route to the LEAs.

6. The adaptation to the LEA IFs is effected in an LEA-specific manner in each case, i.e. a plurality of LEAs with different interface requirements for the same call can be served in parallel.

7. A bandwidth adaptation is performed, where relevant with buffer storage.

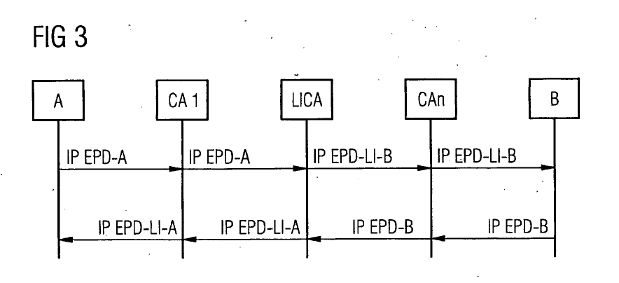

FIG. 3 shows how the IP endpoint data IP-EPD is exchanged between a calling terminal A and a called terminal B. In this respect, the IP endpoint data of the terminal A IP-EPD-A is fed to the assigned Call Agent CA1 via the signaling connection (see also FIG. 2). There, the signaling is analyzed (terminated) and the IP endpoint data IP-EPD-A fed to the controller LICA. This then replaces the IP endpoint data IP-EPD-A by the IP endpoint data IP-EPD-LI-B of the packet multiplexer PMUX. The payload data is therefore always routed via the packet multiplexer in the case of LI and tapped there, controlled by the controller LICA. The replacement does not affect the functionality of the Call Agents CA. The IP endpoint data IP-EPD-B of the called terminal B is similarly replaced by the IP endpoint data IP-EPD-LI-A of the packet multiplexer PMUX.

In the present exemplary embodiment, the tapping of payload data has been shown using the example of video telephony. In this respect, just two different types of connection are involved, specifically a voice connection and a video or picture connection. Further connections, such as data connections, for example, can also be monitored with the method and the device according to the invention.

1.-14. (canceled)

15. A method for tapping the payload data of multimedia connections in a packet network, comprising:
providing a payload stream including an audio payload data and a further payload data;
sending an endpoint-specific data of a first terminal during a connection setup;
receiving an endpoint-specific data of a second terminal during the connection setup;
sending an audio payload data and a further payload data to the second terminal; and
replacing endpoint-specific data of the respective partner end an endpoint-specific data of a tapping device during the duration of a call, such that the payload data streams are guided via the tapping device and tapped.

16. The method as claimed in claim 15, wherein further payload data is a video payload data.

17. The method as claimed in claim 15, wherein the endpoint-specific data includes data referring to IP address, and a port number.

18. The method as claimed in claim 17, wherein the endpoint-specific data includes codec information.

19. A device for tapping the payload data of multimedia connections in a packet network, comprising:
a first controller that replaces an endpoint-specific data of a respective partner end by an endpoint-specific data of a tapping device.

20. The device as claimed in claim 19, wherein the first controller is arranged in a packet-based switching system.

21. The device as claimed in claim 19, wherein the first controller is arranged outside an A-end or a B-end packet-based switching system in the packet network.

22. The device as claimed in claim 19, wherein the first controller is in effective connection with a second controller for a lawful interception.

23. The device as claimed in claim 22, wherein the knowledge about an activation of the lawful interception is established in the first or second controller.

24. The device as claimed in claim 23, wherein the first controller determines the activation of the lawful interception via a directory number analysis.

25. The device as claimed in claim 24, wherein the second controller analyses the directory number and informs the first controller of the activation.

26. A device for tapping a payload data of a multimedia connection in a packet network that transmits audio payload data, and a further payload data, comprising:
a tapping device looped into the payload data streams and that duplicates the payload data streams and feeds them to at least one tasked agency as instructed by a controller.

27. The device as claimed in claim 26, wherein the further payload data is a video payload data.

28. The device as claimed in claim 26, wherein the tapping device implements a distribution of the tapped payload data streams to a large number of tasked agencies.

29. The device as claimed in claim 26, wherein the tapping device is a packet multiplexer that performs a bandwidth adaptation in an LEA-specific manner.

30. The device as claimed in claim 29, wherein the packet multiplexer performs buffer storage of the payload data and a succeeding transmission in the direction of the LEA in an LEA-specific manner.

31. The device as claimed in claim 30, wherein the packet multiplexer performs a recoding of at least one of the payload data streams in the direction of the LEA in an LEA-specific manner.

32. The device as claimed in claim 31, wherein the packet multiplexer feeds the audio payload data, further the payload data to the tasked agencies split as one call in each case where relevant.
